(19) United States
(12) Patent Application Publication
(10) Pub. No.: US 2026/0238848 A1
(43) Pub. Date: Aug. 13, 2026

(54) MIRACAST END TO END (E2E) STREAM TRANSMISSION

(71) Applicant: QUALCOMM Incorporated, San Diego, CA (US)

(72) Inventors: Nan ZHANG, Beijing (CN); Yongjun XU, Beijing (CN); Wenkai YAO, Beijing (CN)

(21) Appl. No.: 19/101,225

(22) PCT Filed: Sep. 21, 2022
(86) PCT No.: PCT/CN2022/120192

§ 371 Date: Feb. 4, 2025

(51) Int. Cl. H04N 21/4363; G06F 3/14; H04N 21/431; H04N 21/83

(52) U.S. Cl. CPC H04N 21/43637; G06F 3/1454; H04N 21/4312; H04N 21/83

(57) ABSTRACT

Various embodiments include systems and methods for supporting Miracast® edge-to-edge (E2E) stream transmission. Various embodiments provide systems and methods for Miracast® E2E stream transmission of partial frame regions. Some embodiments include methods for supporting mirror-casting of video content in a session established between a source wireless device and a sink wireless device.

### BACKGROUND

Long Term Evolution (LTE), fifth generation (5G) new radio (NR), and other recently developed communication technologies allow wireless devices to communicate information at data rates (e.g., in terms of Gigabits per second, etc.) that are orders of magnitude greater than what was available just a few years ago.

Today's communication networks are also more secure, resilient to multipath fading, allow for lower network traffic latencies, provide better communication efficiencies (e.g., in terms of bits per second per unit of bandwidth used, etc.). These and other recent improvements have facilitated the emergence of the Internet of Things (IOT), large scale Machine to Machine (M2M) communication systems, autonomous vehicles, and other technologies that rely on consistent and secure communications.

Miracast® is a technology standard that allows users to wirelessly share multimedia, including high-resolution pictures and high-definition (HD) video content between Wi-Fi® devices. For example, Miracast® enables multimedia to be displayed between wireless devices through Wi-Fi® network connections or Wi-Fi Direct® (WFD) connections.

### SUMMARY

Various aspects include systems and methods for supporting Miracast® edge-to-edge (E2E) stream transmission. Various aspects provide systems and methods for Miracast® E2E stream transmission of partial frame regions. Some aspects include methods for supporting mirror-casting of video content in a session established between a source wireless device and a sink wireless device.

Various aspects include methods for supporting mirror-casting of video content in a session established between a source wireless device and a sink wireless device, which may include generating and encoding a frame of pure filling color by a processor of the source wireless device in response to establishing a session for mirror-casting of video content with the sink wireless device, sending, by the processor of the source wireless device, the encoded frame of pure filling color to the sink wireless device, determining, by the processor of the source wireless device, a valid frame region of interest, sending, by the processor of the source wireless device, an indication of the valid frame region of interest to the sink wireless device, generating and encoding, by the processor of the source wireless device, video content of only the valid frame region of interest as a partial frame; and sending, by the processor of the source wireless device, the partial frame to the sink wireless device.

Some aspects may further include determining, by the processor of the source wireless device, that a change in the valid frame region of interest occurred, generating and encoding a new frame of pure filling color by a processor of the source wireless device in response to determining that the change in the valid frame region of interest occurred, sending, by the processor of the source wireless device, the new encoded frame of pure filling color to the sink wireless device, determining, by the processor of the source wireless device, a new valid frame region of interest, sending, by the processor of the source wireless device, an indication of the new valid frame region of interest to the sink wireless device, generating and encoding, by the processor of the source wireless device, video content of only the new valid frame region of interest as a new partial frame; and sending, by the processor of the source wireless device, the new partial frame to the sink wireless device.

In some aspects, the session for mirror-casting of video content may be a Miracast® End to End (E2E) session. In some aspects, the frame of pure filling color may be a frame of pure black. In some aspects, the indication of the valid frame region of interest may be an indication of a pixel height, a pixel width, and coordinates in a full frame of the valid frame region of interest. In some aspects, the indication of the valid frame region of interest may be a supplemental enhancement information (SEI) message.

Further aspects include methods for supporting mirror-casting of video content in a session established between a source wireless device and a sink wireless device, which may include receiving an encoded frame of pure filling color by a processor of the sink wireless device in response to establishing a session for mirror-casting of video content with the source wireless device, decoding, by the processor of the sink wireless device, the encoded frame of pure filling color as a first full frame, receiving, by the processor of the sink wireless device, an indication of a valid frame region of interest from the source wireless device, receiving, by the processor of the sink wireless device, an encoded partial frame from the source wireless device, decoding the encoded partial frame by the processor of the sink wireless device to generate a partial frame update for the valid frame region of interest, applying, by the processor of the sink wireless device, the partial frame update to the first full frame to generate a new full frame; and displaying, by the processor of the sink wireless device, the new full frame.

In some aspects, the session for mirror-casting of video content is a Miracast® End to End (E2E) session. In some aspects, the frame of pure filling color is a frame of pure black. In some aspects, the indication of the valid frame region of interest is an indication of a pixel height, a pixel width, and coordinates in a full frame of the valid frame region of interest. In some aspects, the indication of the valid frame region of interest is a supplemental enhancement information (SEI) message.

Further aspects may include a wireless device having a processor configured to perform one or more operations of any of the methods summarized above. Further aspects may include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device that includes a processor configured to perform one or more operations of any of the methods summarized above. Further aspects include a system in a package that includes two systems on chip for use in a wireless device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an example communication system suitable for implementing any of the various embodiments.

FIG. 1B is a system block diagram illustrating an example disaggregated base station architecture for wireless communication systems suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a component block diagram illustrating example components of a source wireless device and a sink wireless device suitable for use with various embodiments.

FIG. 5 is a block diagram illustrating aspects of mirror-casting between a source wireless device and a sink wireless device.

FIG. 6 is a process flow diagram illustrating a method for supporting mirror-casting of video content in a session established between a source wireless device and a sink wireless device in accordance with various embodiments.

FIG. 7 is a process flow diagram illustrating a method for supporting mirror-casting of video content in a session established between a source wireless device and a sink wireless device in accordance with various embodiments.

FIG. 8 is a block diagram illustrating aspects of mirror-casting between a source wireless device and a sink wireless device in accordance with various embodiments.

FIG. 9 is a component block diagram of a wireless device suitable for implementing various embodiments.

FIG. 10 is a component block diagram illustrating an example wireless device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide systems and methods for Miracast® end to end (E2E) stream transmission. Various embodiments provide systems and methods for Miracast® E2E stream transmission of partial frame regions. Various embodiments may enable only valid frame regions of content form a source wireless device to be encoded and transmitted to a sink wireless device in a Wi-Fi Direct® (WFD) session. Various embodiments may enable only valid frame regions of content to be decoded at the sink wireless device. Various embodiments may enable WFD mirror-casting without pixel filling, such as without black pixel filling.

The terms “wireless device”, “computing device”, “user equipment”, and “UE” are used herein to refer to any one or all of endpoint or user devices, including wireless devices, wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, Wi-Fi® enabled electronic devices, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, televisions, display units, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, UEs affixed to or incorporated into various mobile platforms, global positioning system devices, and similar electronic devices that include a memory, wireless communication components and a programmable processor.

The term “radio resource” is used herein to refer to hardware, such as modems, radios, processors, transceivers, transmitters, receivers, timers, voltage regulators, oscillators, amplifiers, filters, antennas, circuits, encoders, decoders, etc., and/or software that operate individually, or in any combination, for sending and/or receiving electromagnetic radiation to provide wireless communication services, such as cellular and mobile communication services.

The term “system-on-chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), IEEE 802.11 (Wi-Fi®), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards.

LTE is a mobile network standard for 4G wireless communication of high-speed data developed by the 3GPP (3rd Generation Partnership Project) and specified in its Release 8 document series. In contrast to the circuit-switched (CS) model of cellular network standards, LTE has been designed to support only packet switched (PS) services. Data services in LTE may be provided over the Internet, while multimedia services may be supported by the Internet Multimedia Subsystem (IMS) framework. The LTE standard is based on the evolution of the Universal Mobile Telecommunications System (UMTS) radio access through the Evolved Universal Terrestrial Radio Access Network (E-UTRAN). The E-UTRAN together with the Evolved Packet Core (EPC) network (core network accommodating LTE) make up an Evolved Packet System (EPS). While the access network in UMTS emulates a circuit-switched connection for real time services and a packet-switched connection for datacom services, the Evolved Packet System (EPS) is purely Internet Protocol (IP) based, and both real time services and datacom services are carried by the IP protocol.

The 5G system is an advanced technology from 4G LTE and provides a new radio access technology (RAT) through the evolution of the existing mobile communication network structure. A 5G system may support, for example, extended LTE (eLTE) as well as non-3GPP access (e.g., WLAN).

One implementation option for advanced networks, such as 5G new radio (NR)(5GNR) networks, future generation system networks (e.g., sixth generation (6G) or higher networks), etc., being adopted is a 5G SA network in which a 5G radio access network (RAN) and 5G core network provide 5G services in geographic area, such as a country. As such, 5G SA networks can overlap coverage in the geographic area, such as the country, with LTE networks. 5G SA networks can exclusively include NR base stations, such as Next Generation NodeB (gNodeBs or gNBs).

Another implementation option for advanced systems or networks (e.g., 5G systems or networks, 6G systems or networks, higher generation systems or networks, etc.) currently being adopted is a 5G NSA network in which a RAN providing both LTE (also referred to as 4G) and new radio (NR) (also referred to a 5G) support (e.g., a RAN including both LTE base stations, such as LTE Evolved nodeBs (eNodeBs or eNBs), and NR base stations, such as Next Generation NodeB (gNodeBs or gNBs)) is connected to an LTE core network (e.g., an Evolved Packet Core (EPC) network). A wireless device, sometimes referred to as a user equipment (UE), in such 5G NSA networks that can support both LTE and NR communications can signal to the 5G NSA that the UE supports dual connectivity with new radio (DCNR).

The Miracast@ standard supports a source wireless device wirelessly sharing multimedia, including high-resolution pictures and high-definition (HD) video content, by mirror-casting multimedia content via a Wi-Fi Direct® (WFD) connection with a sink wireless device.

In various embodiments, wireless devices in a wireless network, such as a WFD network, may be categorized as sources and/or sinks depending upon whether the devices are transmitting or receiving content data. Sources or source wireless devices are wireless devices that send content (e.g., content frames, content packets, etc.) to one or more other wireless devices (i.e., sink devices). For example, source wireless devices may operate as a server providing frames or packets to other wireless devices in the wireless network. Sinks or sink wireless devices are wireless devices that receive content (e.g., content frames, content packets, etc.) from one or more other wireless devices. Wireless devices may exclusively operate as sources, exclusively operate as sinks, or operate as both a sink and a source in a wireless network, such as a WFD network. As an example, a WFD network may include a UE acting as a source wirelessly projecting streaming Moving Picture Experts Group (MPEG) format imagery according to the Miracast® standard onto one or more nearby display units acting as one or more sinks.

Various examples of different wireless standards, wireless connections, wireless networks, and wireless media delivery platforms are discussed herein, specifically Miracast® and WFD connections, networks, and media delivery platforms. The discussions of Miracast® and WFD are provided merely as examples to better illustrate the aspects of the various embodiments and are not intended to limit the claims to Miracast® or WFD unless specifically recited. Other wireless standards, wireless connections, wireless networks, and wireless media delivery platforms (e.g., Apple AirPlay®, WiDi®, Chromecast®, etc.) may use or be used with the various embodiments, and other wireless standards, wireless connections, wireless networks, and wireless media delivery platforms may be substituted in the various examples discussed herein.

Wireless media delivery platforms (e.g., Apple AirPlay®, WiDi, Chromecast®, etc.) may support screen mirroring (also sometimes referred to as casting, screen casting, mirroring, or mirror-casting) in which content being displayed on a display of a source wireless device is provided to a display of a sink wireless device. In a WFD session established according to the Miracast® standard between a source wireless device and a sink wireless device, the source wireless device may mirror video output and/or audio output by the source wireless device to the sink wireless device for output by the sink wireless device. The source wireless device encodes content (e.g., video data and/or audio data) output to a display and/or speaker of the source wireless device to generate encoded content (e.g., encoded video data and/or encoded audio data). The source wireless device then packetizes and sends the encoded content (e.g., encoded video data and/or encoded audio data) to the sink wireless device for mirrored output by the sink wireless device. The sink wireless device receives the encoded content (e.g., encoded video data and/or encoded audio data), decodes the content (e.g., video data and/or audio data), and outputs the content (e.g., video data and/or audio data) to a display and/or speaker of the sink wireless device.

The mirror-casting (also sometimes referred to as screen mirroring, casting, screen casting, or mirroring) of content from the source wireless device to the sink wireless device in a WFD session according to the Miracast® standard may be referred to as a Miracast® end to end (E2E) session and the content sent from the source wireless device to the sink wireless device in the WFD session may be referred to as a Miracast® stream.

In a Miracast® E2E session, the source wireless device display resolution and the sink wireless device display resolution may be different. For example, the source wireless device may be a smartphone having a display content resolution of 1080×2400 and the sink wireless device may be a television having display resolution of 3840×2160.

In current WFD mirror-casting, source wireless devices use a conventional 720P/1080P/2160P video encoding-decoding resolution for WFD stream encoding-decoding and transmission of the video content to the sink wireless device. In current WFD mirror-casting, the source wireless device keeps the frame aspect ratio constant and fills any region outside the source content with black pixels to create 720P/1080P/2160P source encoding frames. In current WFD mirror-casting, the sink wireless device receives and decodes the conventional 720P/1080P/2160P WFD streams. In current WFD mirror-casting, the source wireless device encodes content for the WFD stream at a frame resolution 3840×2160p30 and the sink wireless device decodes content of the WFD stream at the same frame resolution, 3840×2160p30.

The filling of black pixels in current WFD mirror-casting does not impact the stream bitrates as the encoding of black pixels does not add bytes to the compression streams. However, filled black pixels are processed the same as other pixels in both source wireless device systems and sink wireless device systems. Thus, in current WFD mirror-casting in which both source wireless devices and sink wireless devices are processing the frame resolution 3840×2160p30, source wireless device and sink wireless device power and resources may be wasted processing redundant black filling pixels.

For example, in current WFD mirror-casting a processor, such as a graphics processing unit (GPU), data processing unit (DPU), etc., needs to generate filling black pixels one by one which has a resource cost in both processor clock time and power consumption by the processor and/or other hardware resources. As another example, in current WFD mirror-casting a video encoding codec at the source wireless device needs to encode filling black pixels and macroblocks one by one which has a resource cost in both encoding codec clock time and power consumption by the video encoding codec and/or other hardware resources. As a further example, in current WFD mirror-casting a video decoding codec at the sink wireless device needs to decode filling black pixels and macroblocks one by one which has a resource cost in both decoding codec clock time and power consumption by the video decoding codec and/or other hardware resources. As another example, in current WFD mirror-casting a sink wireless device memory and display subsystem needs to update/refresh filling black pixels every frame which has a resource cost in both memory bandwidth and display subsystem clock time. Such example resource costs to process redundant filling black pixels in current WFD mirror-casting are a waste of source wireless device and sink wireless device power and performance.

Various embodiments provide methods and systems for supporting mirror-casting of video content in a session established between a source wireless device and a sink wireless device. Various embodiments provide systems and methods for Miracast® E2E stream transmission of partial frame regions. Various embodiments may enable only valid frame regions of content form a source wireless device to be encoded and transmitted to a sink wireless device in a WFD session. Various embodiments may enable only valid frame regions of content to be decoded at the sink wireless device. Various embodiments may enable WFD mirror-casting without pixel filling, such as without black pixel filling or other color pixel filling.

In various embodiments, in response to a WFD session being established between a source wireless device and sink wireless device for WFD mirror-casting, the source wireless device may generate and encode a first frame of pure filling color, such as a pure black frame, a pure blue frame, a pure red frame, etc., and send the encoded pure filling color frame to the sink wireless device. The resolution of the encoded pure filling color frame may match the sink wireless device and WFD session full resolution. As an example, the resolution of the encode pure filling color frame may be 3840×2160. The sink wireless device may receive the encoded pure filling color frame and may decode the pure filling color frame as the first full frame.

In various embodiments, the source wireless device may determine a valid frame region of interest for video content to be mirror-casted in the WFD session. The valid frame region of interest may be a region of a full resolution frame for a Miracast® E2E session in which all the pixels are associated with content being displayed. Said another way, the valid frame region of interest may be a region of a full resolution frame for a Miracast® E2E session in which pixel filling may not need to be applied. For example, a valid frame region of interest for video content to be mirror-casted in a WFD session may be defined by the pixel width and the pixel height of a source frame of the content to be mirror-casted and the location coordinates in the full frame of that source frame. The valid frame region of interest may be the only region of the full frame that may be updated as content is output by the source wireless device.

In various embodiments, the source wireless device may send an indication of the valid frame region of interest for video content to be mirror-casted in a WFD session to the sink wireless device. To send the indication of the valid frame region of interest, the source wireless device may send an indication to the sink wireless device of the pixel width and the pixel height of a source frame of the content to be mirror-casted and the location coordinates in the full frame of that source frame. As an example, the indication of the valid frame region of interest may be sent in as part of a High Efficiency Video Coding (HEVC) refresh function and/or in one or more supplemental enhancement information (SEI) messages sent from the source wireless device to the sink wireless device.

In various embodiments, the next time regular frames are to be generated and encoded after sending the first frame of pure filling color, the source wireless device may generate and encode only the valid frame region of interest for the video content. While the valid frame region of interest remains unchanged, the source wireless device may generate and encode only the valid frame region of interest for the video content. As only the valid frame region of interest is generated and encoded after the first frame of pure filling color is encoded and sent, the frames after the first frame may be frames without pure filling color, such as frames without black pixel filling. The encoding of only the valid frame region may enable the source wireless device to transmit partial frames with only data corresponding to the valid frame region of interest.

In various embodiments, the sink wireless device may receive the encoded partial frame after receiving the encoded pure filling color frame as the first full frame. The sink wireless device may decode the encoded partial frame to generate the partial frame corresponding to the valid frame region of interest. The sink wireless device may use the partial frame corresponding to the valid frame region of interest to update the full frame. As only the coordinates corresponding to the valid frame region of interest may be updated, no resource costs are incurred for the full frame region outside the valid frame region of interest as the full frame region outside the valid frame region of interest is not updated and remains the original pure filling color used in the first full frame.

As one example, a Miracast® E2E session may be established between a source wireless device and a sink wireless device with a full frame resolution of 3480×2160. The source wireless device may generate and encode a first frame of pure black at the 3480×2160 resolution and send the encoded first frame to the sink wireless device. The sink wireless device may decode the first frame and output a first frame of pure black. The source wireless device may determine the valid frame region of interest for the video content is a 972×2160 source frame and may indicate the 972×2160 width/height and location coordinates of the source frame in the full frame to the sink wireless device, such as in a SEI message. The source wireless device may generate and encode only the valid frame region of interest for all frames, specifically only the 972×2160 frame region, after the first frame and send these encoded partial frames to the sink wireless device. The sink wireless device may receive and decode the partial frame and update the previous full frame with the partial frame of the valid frame region of interest thereby only changing the 972×2160 frame region at each subsequent frame render time. As such, the area of the full frame outside the valid frame region of interest may remain the pure black of the original first frame and source wireless device and sink wireless device need only process, generate, encode, and/or decode the 972×2160 frames and corresponding macro blocks.

In various embodiments, the source wireless device may determine that a valid frame region has changed. As examples, a valid frame region may change due to the source wireless device being rotated and/or an application preference for an application running on the source wireless device changing. As one specific example, the valid frame region may change from 972×2160 to 1620×2160. In response to determining that the valid frame region changed, the source wireless device may determine a new valid frame region of interest for video content to be mirror-casted in the WFD session. In various embodiments, the source wireless device may send an indication of the new valid frame region of interest for video content to be mirror-casted in a WFD session to the sink wireless device.

In response to determining that the valid frame region changed, the source wireless device may generate and encode a new frame of pure filling color, such as a pure black frame, a pure blue frame, a pure red frame, etc., and send the encoded pure filling color frame to the sink wireless device. The resolution of the encoded pure filling color frame may match the sink wireless device and WFD session full resolution. As an example, the resolution of the encode pure filling color frame may be 3840×2160. The sink wireless device may receive the encoded pure filling color frame and may decode the pure filling color frame as a new full frame.

In various embodiments, the next time regular frames are to be generated and encoded after sending the new frame of pure filling color, the source wireless device may generate and encode only the new valid frame region of interest for the video content. While the new valid frame region of interest remains unchanged, the source wireless device may generate and encode only the new valid frame region of interest for the video content. As only the new valid frame region of interest is generated and encoded after the new frame of pure filling color is encoded and sent, the frames after the new frame may be frames without pure filling color, such as frames without black pixel filling. The encoding of only the new valid frame region may enable the source wireless device to transmit partial frames with only data corresponding to the new valid frame region of interest.

In various embodiments, the sink wireless device may receive the encoded partial frame after receiving the new encoded pure filling color frame as the new full frame. The sink wireless device may decode the encoded partial frame to generate the partial frame corresponding to the new valid frame region of interest. The sink wireless device may use the partial frame corresponding to the new valid frame region of interest to update the full frame. As only the coordinates corresponding to the new valid frame region of interest may be updated, no resource costs are incurred for the full frame region outside the new valid frame region of interest as the full frame region outside the new valid frame region of interest is not updated and remains the original pure filling color used in the new full frame.

Various embodiments improve the power and performance of source wireless device and sink wireless devices in a Miracast® E2E session. As one example, the clock time spent by a GPU, a DPU, an encode codec, and a decode codec to support mirror-casting in a Miracast® E2E session in accordance with various embodiments may be reduced by 50% or more compared to the clock time spent by a GPU, a DPU, an encode codec, and a decode codec in current WFD mirror-casting. Various embodiments may triple a frame per second (FPS) rate for a WFD session, for example increasing a WFD session capability from 3840×2160p30 to 3840×2160p120. Various embodiments may triple a resolution rate for a WFD session, for example increasing a WFD session capability from 720×1280p30 to 3840×2160p3. Various embodiments may reduce a DPU, an encode codec, and a decode codec clock from 400 megahertz (MHz) to 200 MHz or less as pixels to process compared to those in current WFD mirror-casting may be reduced by 75%.

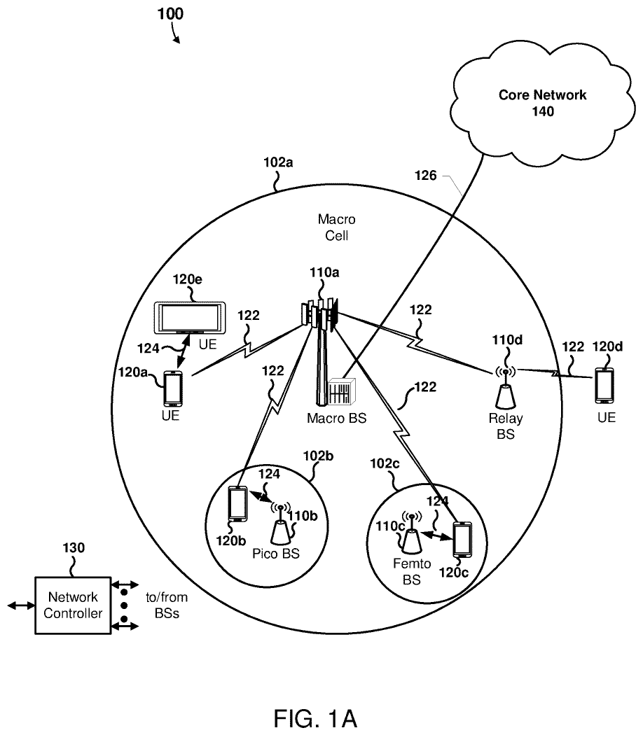

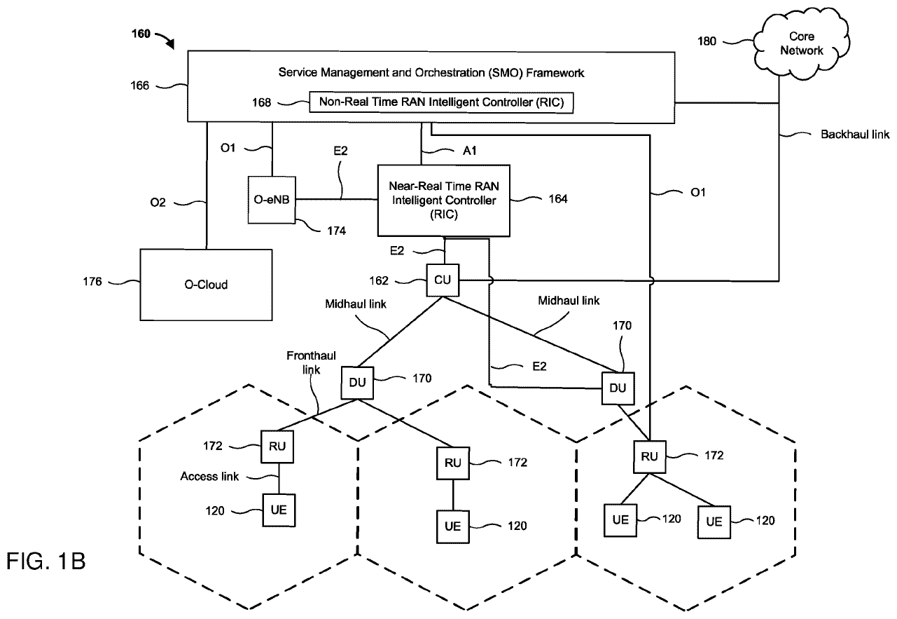

FIG. 1A is a system block diagram illustrating an example communications system 100. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of base stations (illustrated as the BS 110a, the BS 110b, the BS 110c, and the BS 110d) and other network entities. A base station is an entity that communicates with UEs, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type of core network, such as an LTE core network (e.g., an Evolved Packet Core (EPC) network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with a service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1A, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network.

The base station 110a-110d may communicate with the core network 140 over a wired or wireless communication link 126. The UEs 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a UE) and send a transmission of the data to a downstream station (for example, a UE or a base station). A relay station also may be a wireless device (e.g., a UE) that can relay transmissions for other UEs. In the example illustrated in FIG. 1A, a relay station 110d may communicate with macro the base station 110a and the UE 120d in order to facilitate communication between the base station 110a and the UE 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The UEs 120a, 120b, 120c may be dispersed throughout the communications system 100, and each UE may be stationary or mobile. A UE also may be referred to as an access terminal, a terminal, a mobile station, a subscriber unit, a station, wireless device, etc.

A macro base station 110a may communicate with the communication network 140 over a wired or wireless communication link 126. The UEs 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi®, LTE-U, LTE-Direct, LAA, Mul TEfire, and relatively short-range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHZ, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration.

Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data.

Beamforming may be supported, and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported.

Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more UEs (for example, illustrated as the UE 120a and the UE 120e) may communicate directly using one or more sidelink channels (for example, without using a base station 110a-d as an intermediary to communicate with one another). For example, the UEs 120a-120e may communicate using peer-to-peer (P2P) communications, device-to-device (D2D) communications, WFD communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the UE 120a-120e may perform scheduling operations, resource selection operations, as well as other operations described elsewhere herein as being performed by the base station 110a-110d.

In some implementations, one UE 120a-120e may provide content, such as multimedia content, to another one of the UEs 120a-120e. The content may be delivered from an originating one of the UEs 120a-120e acting as a source wireless device to a receiving one of the UEs 120a-120e acting as a sink wireless device via connections 122, 124. The content may be delivered using various protocols, such as WFD, Miracast®, etc. As one example, a WFD session may be established between the source wireless device (or source endpoint) UE 120a-120e and the sink wireless device (or destination endpoint) UE 120a-120e to mirror-cast video content in a Miracast® E2E transmission stream from the source wireless device UE 120a-120e to the sink wireless device UE 120a-120e.

FIG. 1B is a system block diagram illustrating an example disaggregated base station 160 architecture that may be part of communications system (e.g., communications system 100), such as a 5G (or later generation) network, suitable for implementing any of various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, UEs may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an Ol interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an Al interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

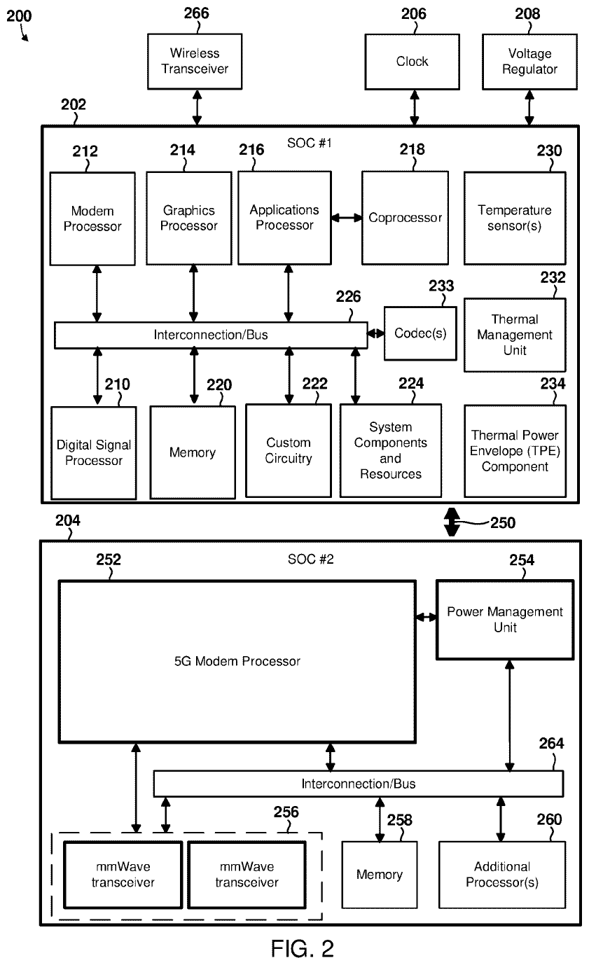

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from UEs, such as a base station 110a. In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wavelength (such as 28 GHz mmWave spectrum, etc.) communications.

The first SOC 202 may include a digital signal processor (DSP) 210, a modem processor 212, a graphics processor (also referred to as a graphics processing unit (GPU)) 214, an application processor 216, one or more coprocessors 218 (such as vector co-processor, a data processing unit (DPU), etc.) connected to one or more of the processors, memory 220, custom circuity 222, system components and resources 224, an interconnection/bus module 226, one or more codecs (e.g., video and/or audio encode codecs, video and/or audio decode codecs, etc.), one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, encoding, decoding, analog-to-digital conversions, wireless data transmissions, and for performing other specialized operations, such as decoding data packets and processing encoded audio and video signals for rendering in a web browser or other displayed application. For example, the system components and resources 224 of the first SOC 202 may include power amplifiers, voltage regulators, oscillators, phase-locked loops, peripheral bridges, data controllers, memory controllers, system controllers, access ports, timers, clocks, decoders, encoders, and other similar components used to support the processors and software clients running on a UE. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, custom circuitry 222, codecs 233, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

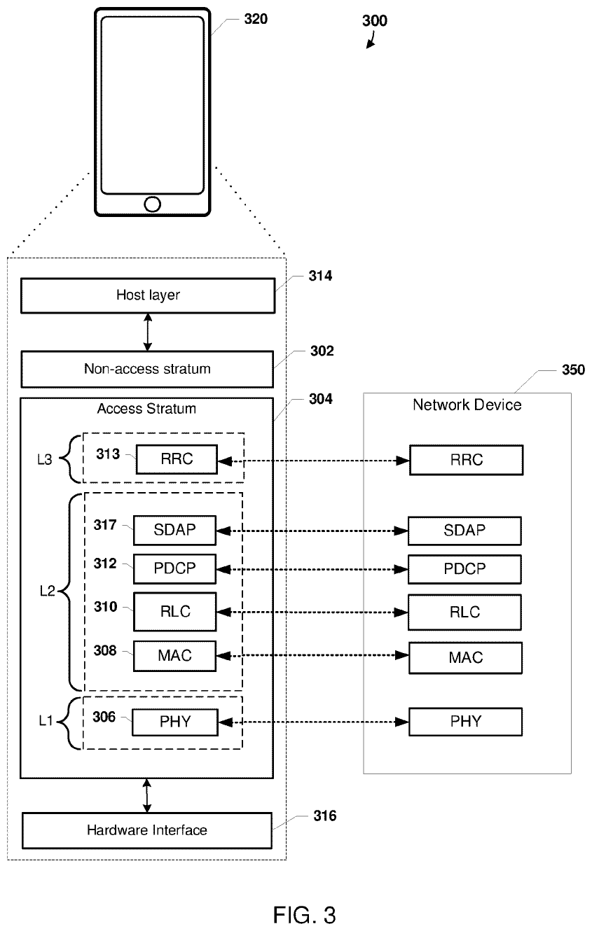

FIG. 3 is a component block diagram illustrating a software architecture 300 including a radio protocol stack for the user and control planes in wireless communications suitable for implementing any of the various embodiments. With reference to FIGS. 1A-3, the UE 320 may implement the software architecture 300 to facilitate communication between a UE 320 (e.g., the UE 120, 120a-120e, 200) and a network device 350 of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a multi-SIM (subscriber identity module) UE, the software architecture 300 may include multiple protocol stacks, each of which may be associated with a different subscriber identity module (SIM) (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network device 350 over the physical layer 306. In some implementations, Layer 2 may include a media access control (MAC) sublayer 308, a radio link control (RLC) sublayer 310, and a packet data convergence protocol (PDCP) 312 sublayer,, and a Service Data Adaptation Protocol (SDAP) 317 sublayer each of which form logical connections terminating at the network device 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network device 350.

In various embodiments, the SDAP sublayer 317 may provide mapping between Quality of Service (QOS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

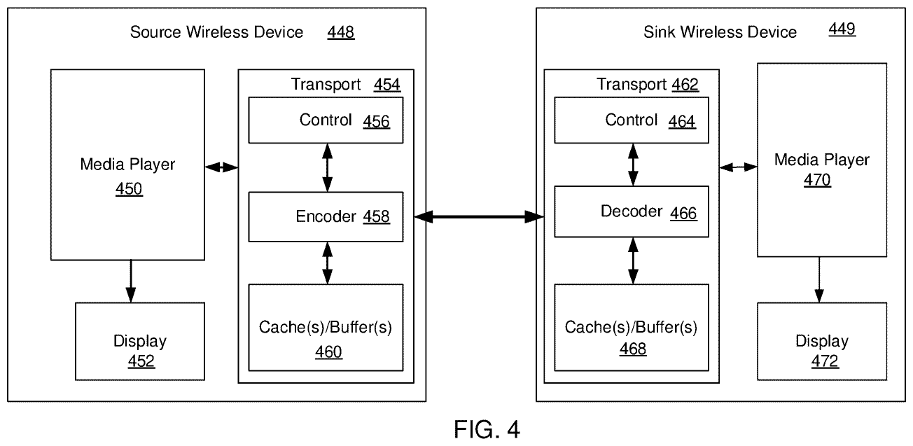

FIG. 4 is a block diagram illustrating example components of a source wireless device 448 and a sink wireless device 449 configured for direct streaming with one another. With reference to FIGS. 1A-1B, the source wireless device 448 may be any wireless device (e.g., the UE 120, 120a-120e, 200, 320) providing content (e.g., content frames, content packets, etc.) to the sink wireless device 449. Similarly, the sink wireless device may be any wireless device (e.g., the UE 120, 120a-120e, 200, 320) receiving content from the source wireless device 448.

The source wireless device 448 may include a media player component 450, a transport component 454, and a display component 452. The sink wireless device 449 may include a media player component 470, a transport component 462, and a decoder component 466. The media player component 470 may send video frames to a display component 472.

As used herein, the term “component” refers to a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The media player components 450, 470 may be combinations of one or more other components of the source wireless device 448 and sink wireless device 449, respectively. For example, a media player component may be a combination of a network element component configured to fetch data from a network, a decoder component configured to decode fetched compressed data, and a media renderer component configured to perform audio-visual (AV) synchronization operations. As an alternative example, a media player component may merely be a media renderer component that sends media data, such as decoded video frames to a display component, decoded audio samples to a sound card, etc. In some embodiments, the media player component 450 of the source wireless device 448 may include different components than the media player component 470 of the sink wireless device 449.

The media player component 450 of the source wireless device 448 may send content to the transport component 454 to be sent to the sink wireless device 449. The decoder component 466 may decode content and the resulting content may be processed by the AV synch operations of the media player component 450. The media player component 450 may include various internal components, such as AV synch components, decoder components, codec components, etc., configured to support playout of a media stream. The media player component 450 may output content to the display component 452 for rendering to a user of the source wireless device 448. The media player component 450 may send notifications of operations performed on the content (e.g., notifications of presentation time stamps, notifications or decoding time stamps, notifications of AV synch operations, notifications of rendering content, notifications of dropping content, etc.) to the transport component 454. The display component 452 may control a screen, speaker, and/or other user interface to render the content to the user.

The transport component 454 of the source wireless device 448 may send packets, such as packets including content, packets including meta data, packets including messages, etc., to the transport component 462 of the sink wireless device 449. The transport component 454 of the source wireless device 448 may receive packets, such as packets including control information, session information, reply messages, etc., from the transport component 462 of the sink wireless device 449. The transport component 462 of the sink wireless device 449 may receive packets, such as packets including content, packets including meta data, packets including messages, etc., from the transport component 454 of the source wireless device 448. The transport component 462 of the sink wireless device 449 may send packets, such as packets including control information, session information, reply messages, etc., to the transport component 454 of the source wireless device 448. As examples, the transport component 454 and the transport component 462 may each be components (e.g., WFD components, Miracast® components, Apple AirPlay® components, WiDi components, etc.) configured to establish Wi-Fi connections with one another and exchange communications over the established Wi-Fi connections.

The transport component 454 of the source wireless device 448 may include a control component 456 configured to control operations of the transport component 454. As examples, the control component 456 may monitor the sending of packets by the transport component 454, may control the transmission bandwidth at which packets are sent by the transport component 454, may control an encoder component 458 to generate packets (e.g., transport packets, presentation packets, etc.), may direct packets to be stored, retrieved, and/or removed from one or more caches and/or buffers 460, may determine capabilities of the sink wireless device 449 through capability messages, may monitor notifications from other components of the source wireless device 448, such as the media player component 450, may indicate render statuses of packets handled by the media player component 450 to the sink wireless device 449, etc. The transport component 454 may include an encoder component 458 configured to encode packets for transport to the sink wireless device 449. For example, the encoder component 458 may generate transport packets and presentation packets for transmission to the sink wireless device 449. In some modes of operation, the encoder component 458 may be used to encode frames captured from the display component 452. The transport component 454 may include one or more caches and/or buffers 460 configured to store packets and other data. As examples, the one or more caches and/or buffers 460 may include a transport packet buffer (e.g., a pre-transmit-queue, etc.) that may be a first-in-first-out (FIFO) queue storing transport packets for transmission to the sink wireless device 449.

The transport component 462 of the sink wireless device 449 may include a control component 464 configured to control operations of the transport component 462. As examples, the control component 464 may monitor the receipt of packets by the transport component 462, may direct packets to be stored, retrieved, and/or removed from one or more caches and/or buffers 468, may control the decoder component 466 to decode packets from the source wireless device 448, may indicate capabilities to the source wireless device 448 through reply messages, may determine render statuses indicated by the source wireless device 448, may drop decoded packets, may send decoded packets to the media player component 470 of the sink wireless device 449, etc.

The transport component 462 may include a decoder component 466 configured to decode packets received from the source wireless device 448. For example, the decoder component 466 may decode transport packets and presentation packets received from the source wireless device 448. The transport component 462 may include one or more caches and/or buffers 468 configured to store packets and other data. As examples, the one or more caches and/or buffers 468 may include a decoded packet buffer (e.g., a pre-transmitted data buffer, etc.) that may store data from decoded transport packets received from the source wireless device 448.

The media player component 470 of the sink wireless device 449 may receive content from the transport component 462 sent from the source wireless device 448. The media player component 470 may decode content, for example via controlling operations of the decoder component 466, and the resulting content may be processed by the AV synch operations of the media player component 470. The media player component 470 may include various internal components, such as AV synch components, decoder components, codec components, etc., configured to support playout of a media stream. The media player component 470 (e.g., a renderer component of the media player component 470) may output content to the display component 472 for rendering to a user of the sink wireless device 449. The display component 472 may control a screen, speaker, and/or other user interface to render the content to the user.

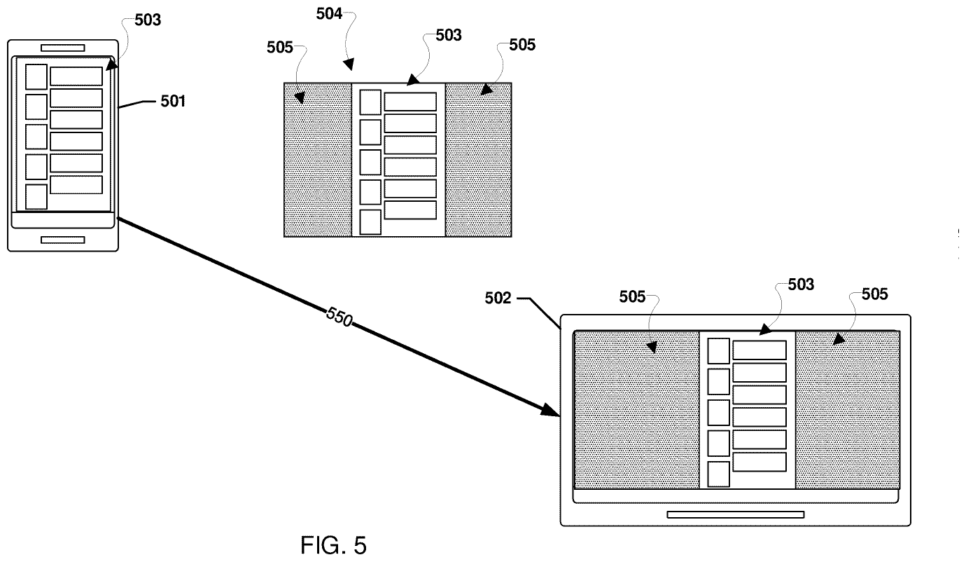

FIG. 5 is a block diagram illustrating aspects of mirror-casting between a source wireless device 501 and a sink wireless device 502. With reference to FIGS. 1-5, the source wireless device 501 (e.g., the UE 120, 120a-120e, 200, 320, 448) and the sink wireless device 502 (e.g., the UE 120, 120a-120e, 200, 320, 449) may have established a WFD session with one another according to the Miracast® standard (e.g., a Miracast® E2E session) to send a Miracast® stream 550 for mirror casting the displayed video content 503 of the source wireless device 501 to the sink wireless device 502 for output on the display of the sink wireless device 502, The source wireless device 501 display resolution and the sink wireless device 502 display resolution may be different. For example, the source wireless device 501 may be a smartphone having a display content resolution of 1080×2400 and the sink wireless device 502 may be a television having display resolution of 3840×2160.

In current WFD mirror-casting, the source wireless device 501 uses a conventional 720P/1080P/2160P video encoding-decoding resolution for WFD stream encoding-decoding and transmission of the video content 503 to the sink wireless device 502. In current WFD mirror-casting, the source wireless device 501 keeps the frame aspect ratio constant and fills any region outside the source content 503 with black pixels 505 to create 720P/1080P/2160P source encoding frames 504. In current WFD mirror-casting, the sink wireless device 502 receives and decodes the conventional 720P/1080P/2160P frames 504 in the Miracast® stream 550. In current WFD mirror-casting, the source wireless device 501 encodes content 503 for the Miracast@ stream 550 at a frame resolution 3840×2160p30 and the sink wireless device 502 decodes content of the Miracast® stream 550 at the same frame resolution, 3840×2160p30.

The filling of black pixels 505 in current WFD mirror-casting does not impact the stream bitrates as the encoding of black pixels 505 does not add bytes to the compression streams. However, filled black pixels 505 are processed the same as other pixels in both the source wireless device 501 and sink wireless device 502. Thus, with both the source wireless device 501 and the sink wireless device 502 processing the frame resolution 3840×2160p30, the source wireless device 501 and sink wireless device 502 power and resources may be wasted processing redundant black filling pixels 505.

Various embodiments may provide methods and systems for supporting mirror-casting of video content in a session established between a source wireless device and a sink wireless device. Various embodiments provide systems and methods for Miracast® E2E stream transmission of partial frame regions. Various embodiments may enable only valid frame regions of content form a source wireless device to be encoded and transmitted to a sink wireless device in a WFD session. Various embodiments may enable only valid frame regions of content to be decoded at the sink wireless device. Various embodiments may enable WFD mirror-casting without pixel filling, such as without black pixel filling or other color pixel filling.

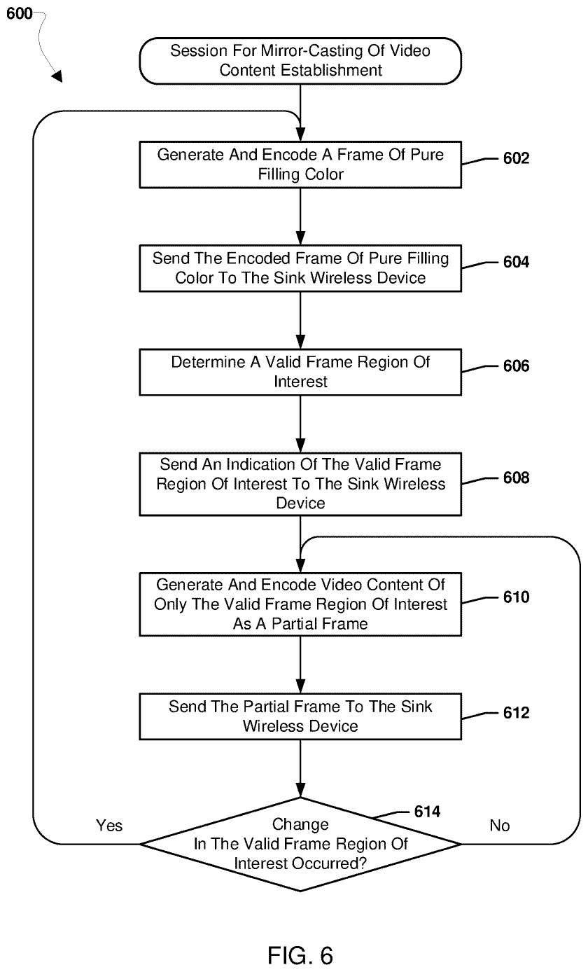

FIG. 6 shows a process flow diagram of an example method 600 for supporting mirror-casting of video content in a session established between a source wireless device and a sink wireless device in accordance with various embodiments. With reference to FIGS. 1A-6, the method 600 may be implemented by a processor (such as 210, 212, 214, 216, 218, 252, 260) of a source wireless device (such as the UE 120, 120a-120e, 200, 320, 448, 501) in a session, such as a WFD session, Miracast® E2E session, etc. established with a sink wireless device (such as the UE 120, 120a-120e, 200, 320, 448, 502). With reference to FIGS. 1A-6, means for performing each of the operations of method 600 may be one or more processors of a UE (such as the UE 120, 120a-120e, 200, 320, 448, 501), for example one or more processors 210, 212, 214, 216, 218, 252, 260. In various embodiments, the operations of method 600 may be performed by a source wireless device in response to a session for mirror-casting of video content being established with a sink wireless device.

In block 602, the processor may perform operations including generating and encoding a frame of pure filling color. The generating and encoding a frame of pure filling color may be performed in response to establishing a session for mirror-casting of video content with the sink wireless device. The frame of pure filling color may be a full frame of any color, such as a pure black frame, a pure blue frame, a pure red frame, etc. The resolution of the encoded pure filling color frame may match the sink wireless device and WFD session full resolution. As an example, the resolution of the encode pure filling color frame may be 3840×2160. Means for performing the operations of block 602 may include one or more processors of a UE (such as the UE 120, 120a-120e, 200, 320, 448, 501), for example one or more processors 210, 212, 214, 216, 218, 252, 260.

In block 604, the processor may perform operations including sending the encoded frame of pure filling color to the sink wireless device. For example, the encoded frame of pure filling color may be sent via a Miracast® E2E transport stream. Means for performing the operations of block 604 may include one or more processors of a UE (such as the UE 120, 120a-120e, 200, 320, 448, 501), for example one or more processors 210, 212, 214, 216, 218, 252, 260.

In block 606, the processor may perform operations including determining a valid frame region of interest. The valid frame region of interest may be a region of a full resolution frame for a Miracast® E2E session in which all the pixels are associated with content being displayed. Said another way, the valid frame region of interest may be a region of a full resolution frame for a Miracast® E2E session in which pixel filling may not need to be applied. For example, a valid frame region of interest for video content to be mirror-casted in a WFD session may be defined by the pixel width and the pixel height of a source frame of the content to be mirror-casted and the location coordinates in the full frame of that source frame. The valid frame region of interest may be the only region of the full frame that may be updated as content is output by the source wireless device. Means for performing the operations of block 606 may include one or more processors of a UE (such as the UE 120, 120a-120e, 200, 320, 448, 501), for example one or more processors 210, 212, 214, 216, 218, 252, 260.

In block 608, the processor may perform operations including sending an indication of the valid frame region of interest to the sink wireless device. To send the indication of the valid frame region of interest, the source wireless device may send an indication to the sink wireless device of the pixel width and the pixel height of a source frame of the content to be mirror-casted and the location coordinates in the full frame of that source frame. As an example, the indication of the valid frame region of interest may be sent in as part of a High Efficiency Video Coding (HEVC) refresh function and/or in one or more supplemental enhancement information (SEI) messages sent from the source wireless device to the sink wireless device. Means for performing the operations of block 608 may include one or more processors of a UE (such as the UE 120, 120a-120e, 200, 320, 448, 501), for example one or more processors 210, 212, 214, 216, 218, 252, 260.

In block 610, the processor may perform operations including generating and encoding video content of only the valid frame region of interest as a partial frame. In various embodiments, the next time regular frames are to be generated and encoded after sending the first frame of pure filling color, the source wireless device may generate and encode only the valid frame region of interest for the video content. While the valid frame region of interest remains unchanged, the source wireless device may generate and encode only the valid frame region of interest for the video content. As only the valid frame region of interest is generated and encoded after the first frame of pure filling color is encoded and sent, the frames after the first frame may be frames without pure filling color, such as frames without black pixel filling. The encoding of only the valid frame region may enable the source wireless device to transmit partial frames with only data corresponding to the valid frame region of interest. Means for performing the operations of block 610 may include one or more processors of a UE (such as the UE 120, 120a-120e, 200, 320, 448, 501), for example one or more processors 210, 212, 214, 216, 218, 252, 260.

In block 612, the processor may perform operations including sending the partial frame to the sink wireless device. For example, the partial frame may be sent via a Miracast® E2E transport stream. Means for performing the operations of block 612 may include one or more processors of a UE (such as the UE 120, 120a-120e, 200, 320, 448, 501), for example one or more processors 210, 212, 214, 216, 218, 252, 260.

In determination block 614, the processor may determine whether a change in the valid frame region of interest has occurred. As examples, a valid frame region may change due to the source wireless device being rotated and/or an application preference for an application running on the source wireless device changing. As one specific example, the valid frame region may change from 972×2160 to 1620×2160. Means for performing the operations of determination block 614 may include one or more processors of a UE (such as the UE 120, 120a-120e, 200, 320, 448, 501), for example one or more processors 210, 212, 214, 216, 218, 252, 260.

In response to determining that the valid frame region of interest has not changed (i.e., determination block 614=“No”), the processor may continue to perform operations to generate, encode, and send partial frames in blocks 610 and 612. In response to determining that the valid frame region of interest has not changed (i.e., determination block 614=“No”), the processor may generate a new encoded frame of pure filling color in block 602. The processor may determine a new valid frame region of interest, send and indication of the valid frame region of interest, and generate and encode partial frames in blocks 604-612.

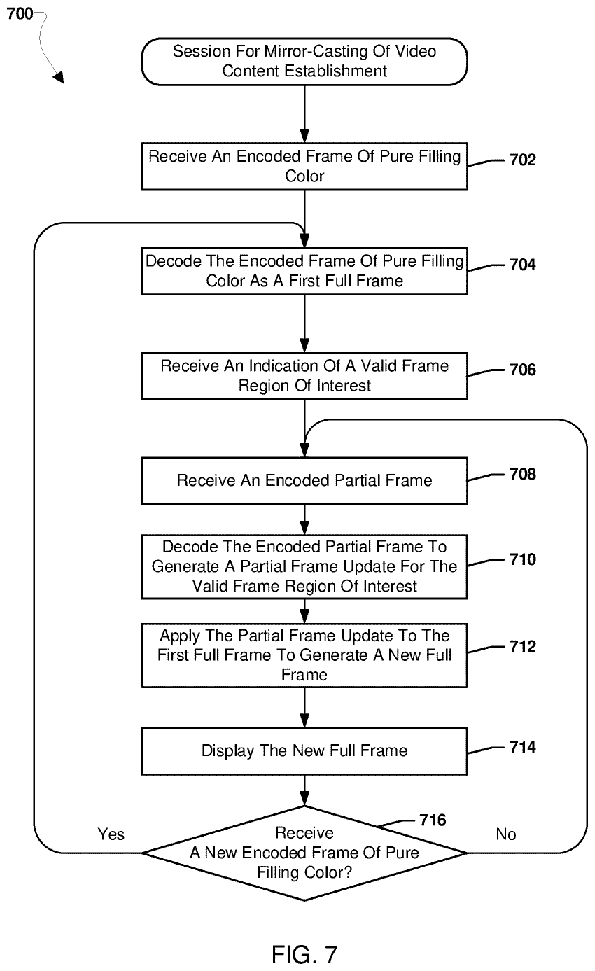

FIG. 7 shows a process flow diagram of an example method 700 for supporting mirror-casting of video content in a session established between a source wireless device and a sink wireless device in accordance with various embodiments. With reference to FIGS. 1A-7, the method 700 may be implemented by a processor (such as 210, 212, 214, 216, 218, 252, 260) of a sink wireless device (such as the UE 120, 120a-120e, 200, 320, 449, 502) in a session, such as a WFD session, Miracast® E2E session, etc. established with a source wireless device (such as the UE 120, 120a-120e, 200, 320, 448, 501). With reference to FIGS. 1A-7, means for performing each of the operations of method 600 may be one or more processors of a UE (such as the UE 120, 120a-120e, 200, 320, 449, 502), for example one or more processors 210, 212, 214, 216, 218, 252, 260. In various embodiments, the operations of method 700 may be performed in conjunction with the operations of method 600 (FIG. 6). In various embodiments, the operations of method 700 may be performed by a sink wireless device in response to a session for mirror-casting of video content being established with a source wireless device.

In block 702, the processor may perform operations including receiving an encoded frame of pure filling color. The receiving of the encoded frame of pure filling color may be in response to establishing a session for mirror-casting of video content with the source wireless device. For example, the encoded frame of pure filling color may be received via a Miracast® E2E transport stream. The frame of pure filling color may be a full frame of any color, such as a pure black frame, a pure blue frame, a pure red frame, etc. The resolution of the encoded pure filling color frame may match the sink wireless device and WFD session full resolution. As an example, the resolution of the encode pure filling color frame may be 3840×2160. Means for performing the operations of block 702 may include one or more processors of a UE (such as the UE 120, 120a-120e, 200, 320, 449, 502), for example one or more processors 210, 212, 214, 216, 218, 252, 260.

In block 704, the processor may perform operations including decoding the encoded frame of pure filling color as a first full frame. The decoding of the pure filling color full frame may provide the sink wireless device with a full resolution frame of one single color, such as a full resolution black frame, full resolution blue frame, etc. Means for performing the operations of block 704 may include one or more processors of a UE (such as the UE 120, 120a-120e, 200, 320, 449, 502), for example one or more processors 210, 212, 214, 216, 218, 252, 260.

In block 706, the processor may perform operations including receiving an indication of a valid frame region of interest from the source wireless device. The valid frame region of interest may be a region of a full resolution frame for a Miracast® E2E session in which all the pixels are associated with content being displayed. Said another way, the valid frame region of interest may be a region of a full resolution frame for a Miracast® E2E session in which pixel filling may not need to be applied. For example, a valid frame region of interest for video content to be mirror-casted in a WFD session may be defined by the pixel width and the pixel height of a source frame of the content to be mirror-casted and the location coordinates in the full frame of that source frame. The valid frame region of interest may be the only region of the full frame that may be updated as content is output by the source wireless device. The indication of the valid frame region of interest may be an indication to the sink wireless device of the pixel width and the pixel height of a source frame of the content to be mirror-casted and the location coordinates in the full frame of that source frame. As an example, the indication of the valid frame region of interest may be received as part of a High Efficiency Video Coding (HEVC) refresh function and/or in one or more supplemental enhancement information (SEI) messages received from the source wireless device. Means for performing the operations of block 706 may include one or more processors of a UE (such as the UE 120, 120a-120e, 200, 320, 449, 502), for example one or more processors 210, 212, 214, 216, 218, 252, 260.

In block 708, the processor may perform operations including receiving an encoded partial frame from the source wireless device. In various embodiments, the sink wireless device may receive the encoded partial frame after receiving the encoded pure filling color frame as the first full frame. For example, the encoded partial frame may be received via a Miracast® E2E transport stream. Means for performing the operations of block 708 may include one or more processors of a UE (such as the UE 120, 120a-120e, 200, 320, 449, 502), for example one or more processors 210, 212, 214, 216, 218, 252, 260.

In block 710, the processor may perform operations including decoding the encoded partial frame to generate a partial frame update for the valid frame region of interest. The sink wireless device may decode the encoded partial frame to generate the partial frame corresponding to the valid frame region of interest. The sink wireless device may use the partial frame corresponding to the valid frame region of interest to update the full frame. As only the coordinates corresponding to the valid frame region of interest may be updated, no resource costs are incurred for the full frame region outside the valid frame region of interest as the full frame region outside the valid frame region of interest is not updated and remains the original pure filling color used in the first full frame. Means for performing the operations of block 710 may include one or more processors of a UE (such as the UE 120, 120a-120e, 200, 320, 449, 502), for example one or more processors 210, 212, 214, 216, 218, 252, 260.

In block 712, the processor may perform operations including displaying the new full frame. The new full frame may be a mix of the pure filling color outside the valid frame region of interest and the updated content from the source wireless device within the valid frame region of interest. Means for performing the operations of block 712 may include one or more processors of a UE (such as the UE 120, 120a-120e, 200, 320, 449, 502), for example one or more processors 210, 212, 214, 216, 218, 252, 260.

In determination block 714, the processor may perform operations including determining whether a new encoded frame of pure filling color is received. In various embodiments, a source wireless device may send a new encoded frame of pure filling color when the valid frame region of interest changes. Means for performing the operations of block 714 may include one or more processors of a UE (such as the UE 120, 120a-120e, 200, 320, 449, 502), for example one or more processors 210, 212, 214, 216, 218, 252, 260.

In response to determining that a new encoded frame of pure filling color is not received (i.e., determination block 716=“No”), the processor may continue to receive encoded partial frames in block 708 and perform operations of blocks 710, 712, and 714 to continue to update the valid frame region of interest. In response to determining that a new encoded frame of pure filling color is received (i.e., determination block 716=“Yes”), the processor may decode the encoded frame of pure filling color as a new full frame in block 704 and perform operations of blocks 706, 708, 710, 712, and 714 to display partial updates to the new full frame of the new valid frame region of interest.

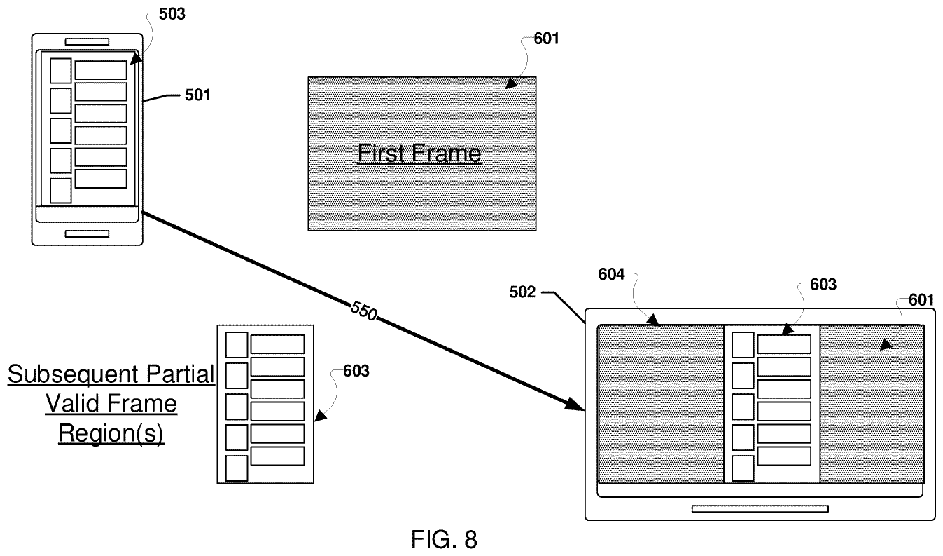

FIG. 8 is a block diagram illustrating aspects of mirror-casting between a source wireless device 501 and a sink wireless device in accordance with various embodiments. With reference to FIGS. 1-8, the source wireless device 501 (e.g., the UE 120, 120a-120e, 200, 320, 448) and the sink wireless device 502 (e.g., the UE 120, 120a-120e, 200, 320, 449) may have established a WFD session with one another according to the Miracast@ standard (e.g., a Miracast® E2E session) to send a Miracast® stream 550 for mirror casting the displayed video content 503 of the source wireless device 501 to the sink wireless device 502 for output on the display of the sink wireless device 502. FIG. 8 may illustrate an example implementation of one or more operations of methods 600 (FIGS. 6) and/or 700 (FIG. 7). The first full frame 601 may be a pure filling color frame, such a pure black frame, pure blue frame, etc., sent at the full resolution of the session. As one example, a Miracast® E2E session may be established between a source wireless device and a sink wireless device with a full frame resolution of 3480×2160.

The source wireless device 501 may generate and encode the first frame 601 of pure black at the 3480×2160 resolution and send the encoded first frame 601 to the sink wireless device 502. The sink wireless device 502 may decode the first frame 601 and output a first frame of pure black. The source wireless device 501 may determine the valid frame region of interest for the video content is a 972×2160 source frame and may indicate the 972×2160 width/height and location coordinates of the source frame in the full frame to the sink wireless device 502, such as in a SEI message. The source wireless device 501 may generate and encode only the valid frame region of interest for all frames, specifically only the 972×2160 frame region, after the first frame and send these encoded partial frames 603 to the sink wireless device 502.

The sink wireless device 502 may receive and decode the partial frame 603 and update the previous full frame with the partial frame of the valid frame region of interest thereby only changing the 972×2160 frame region at each subsequent frame render time. In the newly rendered updated frame 604, the area of the full frame 604 outside the valid frame region of interest 603 may remain the pure black of the original first frame 601 and source wireless device 501 and sink wireless device 502 need only process, generate, encode, and/or decode the 972×2160 frames and corresponding macro blocks.

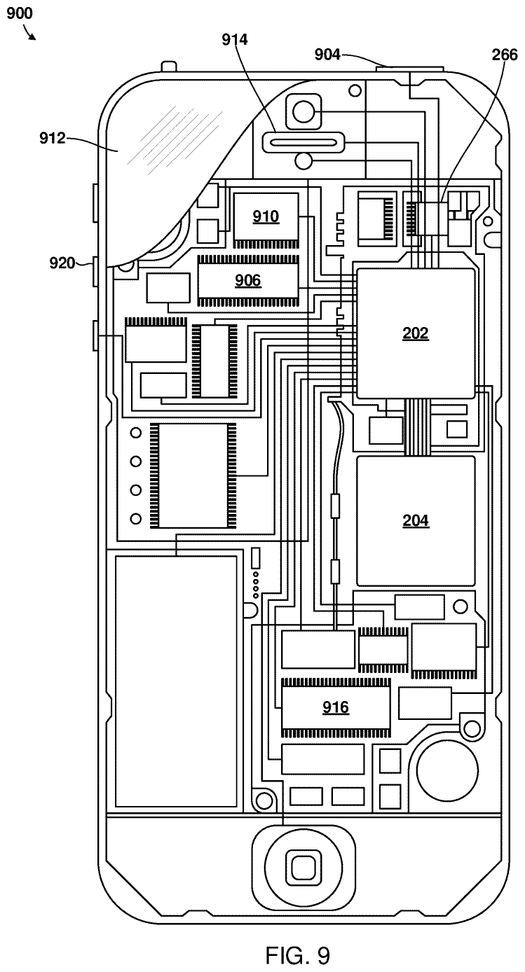

Various embodiments may be implemented on a variety of wireless devices (e.g., the wireless device 120, 120a-120e, 200, 320, 448, 449, 501, 502), an example of which is illustrated in FIG. 9 in the form of a smartphone 900. With reference to FIGS. 1A-9, the smartphone 900 may include a first SOC 202 (e.g., a SOC-CPU) coupled to a second SOC 204 (e.g., a 5G capable SOC). The first and second SOCs 202, 204 may be coupled to internal memory 906, 916, a display 912, and to a speaker 914. Additionally, the smartphone 900 may include an antenna 904 for sending and receiving electromagnetic radiation that may be connected to a wireless data link and/or cellular telephone transceiver 266 coupled to one or more processors in the first and/or second SOCs 202, 204. Smartphones 900 typically also include menu selection buttons or rocker switches 920 for receiving user inputs.

A typical smartphone 900 also includes a sound encoding/decoding (CODEC) circuit 910, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 910 may include a digital signal processor (DSP) circuit (not shown separately).

The processors of the head-mounted device 1572, wireless network computing device 1600, the smart phone 900 may be any programmable microprocessor, microcomputer or multiple processor chip or chips that can be configured by software instructions (applications) to perform a variety of functions, including the functions of the various embodiments described below. In some wireless devices, multiple processors may be provided, such as one processor within an SOC 204 dedicated to wireless communication functions and one processor within an SOC 202 dedicated to running other applications. Typically, software applications may be stored in the memory 906, 916 before they are accessed and loaded into the processor. The processors may include internal memory sufficient to store the application software instructions.

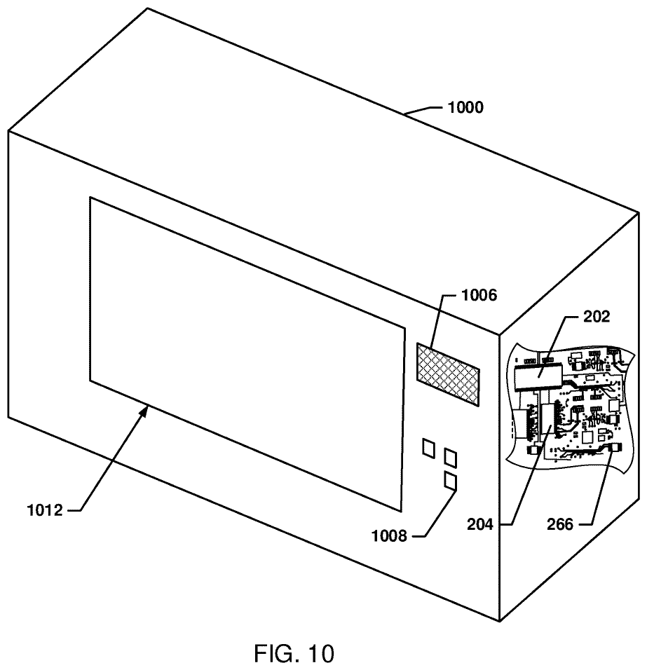

Various embodiments may also be implemented on a variety of wireless devices (e.g., the wireless device 120, 120a-120e, 200, 320, 448, 449, 501, 502), such as display unit 1000 illustrated in FIG. 10. With reference to FIGS. 1A-10, a display unit 1000 may include a first SOC 202 (e.g., a SOC-CPU) coupled to a second SOC 204 (e.g., a 5G capable SOC). The first and second SOCs 202, 204 may be coupled to a memory 1004. The display unit 1000 may include a speaker 1006 that may be connected to the SOCs 202, 204 and configured to output sound. The display unit 1000 may also include one or more radio signal transceivers 266 (e.g., Bluetooth®, ZigBee®, Wi-Fi®, RF radio, etc.) and antennae, for sending and receiving, coupled to each other and/or to the SOCs 202, 204. The transceivers 266 and antennae may be used to implement the various wireless transmission protocol stacks and interfaces. The display unit 1000 may also include a touchpad 1008 and screen 1012 all coupled to the SOCs 202, 204.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA 1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi® Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 600 and/or 700 may be substituted for or combined with one or more operations of the methods 600 and/or 700.

Implementation examples are described in the following paragraphs. While some of the following implementation examples are described in terms of example methods, further example implementations may include: the example methods discussed in the following paragraphs implemented by a computing device including a processor configured to perform operations of the example methods; the example methods discussed in the following paragraphs implemented by a computing device including means for performing functions of the example methods; and the example methods discussed in the following paragraphs implemented as a non-transitory processor-readable storage medium having stored thereon processor-executable instructions configured to cause a processor of a computing device to perform the operations of the example methods.

Example 1. A method for supporting mirror-casting of video content in a session established between a source wireless device and a sink wireless device, including: generating and encoding a frame of pure filling color by a processor of the source wireless device in response to establishing a session for mirror-casting of video content with the sink wireless device; sending, by the processor of the source wireless device, the encoded frame of pure filling color to the sink wireless device; determining, by the processor of the source wireless device, a valid frame region of interest; sending, by the processor of the source wireless device, an indication of the valid frame region of interest to the sink wireless device; generating and encoding, by the processor of the source wireless device, video content of only the valid frame region of interest as a partial frame; and sending, by the processor of the source wireless device, the partial frame to the sink wireless device.

Example 2. The method of example 1, further including: determining, by the processor of the source wireless device, that a change in the valid frame region of interest occurred; generating and encoding a new frame of pure filling color by a processor of the source wireless device in response to determining that the change in the valid frame region of interest occurred; sending, by the processor of the source wireless device, the new encoded frame of pure filling color to the sink wireless device; determining, by the processor of the source wireless device, a new valid frame region of interest; sending, by the processor of the source wireless device, an indication of the new valid frame region of interest to the sink wireless device; generating and encoding, by the processor of the source wireless device, video content of only the new valid frame region of interest as a new partial frame; and sending, by the processor of the source wireless device, the new partial frame to the sink wireless device.

Example 3. The method of either of examples 1 or 2, in which the session for mirror-casting of video content is a Miracast® End to End (E2E) session.

Example 4. The method of example 3, in which the frame of pure filling color is a frame of pure black.

Example 5. The method of any of examples 1-4, in which the indication of the valid frame region of interest is an indication of a pixel height, a pixel width, and coordinates in a full frame of the valid frame region of interest.

Example 6. The method of example 5, in which the indication of the valid frame region of interest is a supplemental enhancement information (SEI) message.

Example 7. A method for supporting mirror-casting of video content in a session established between a source wireless device and a sink wireless device, including: receiving an encoded frame of pure filling color by a processor of the sink wireless device in response to establishing a session for mirror-casting of video content with the source wireless device; decoding, by the processor of the sink wireless device, the encoded frame of pure filling color as a first full frame; receiving, by the processor of the sink wireless device, an indication of a valid frame region of interest from the source wireless device; receiving, by the processor of the sink wireless device, an encoded partial frame from the source wireless device; decoding the encoded partial frame by the processor of the sink wireless device to generate a partial frame update for the valid frame region of interest; applying, by the processor of the sink wireless device, the partial frame update to the first full frame to generate a new full frame; and displaying, by the processor of the sink wireless device, the new full frame.

Example 8. The method of example 7, in which the session for mirror-casting of video content is a Miracast® End to End (E2E) session.

Example 9. The method of example 8, in which the frame of pure filling color is a frame of pure black.

Example 10. The method of any of examples 7-9, in which the indication of the valid frame region of interest is an indication of a pixel height, a pixel width, and coordinates in a full frame of the valid frame region of interest.

Example 11. The method of example 10, in which the indication of the valid frame region of interest is a supplemental enhancement information (SEI) message.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A wireless device, comprising:
a wireless transceiver; and
a processor coupled to the wireless transceiver and configured to:
generate and encode a frame of pure filling color in response to establishing a session for mirror-casting of video content with a sink wireless device;
send the encoded frame of pure filling color to the sink wireless device;
determine a valid frame region of interest;
send an indication of the valid frame region of interest to the sink wireless device;
generate and encode video content of only the valid frame region of interest as a partial frame; and
send the partial frame to the sink wireless device.

2. The wireless device of claim 1, wherein the processor is further configured to:
determine that a change in the valid frame region of interest occurred;
generate and encode a new frame of pure filling color by a processor of the source wireless device in response to determining that the change in the valid frame region of interest occurred;
send the new encoded frame of pure filling color to the sink wireless device;
determine a new valid frame region of interest;
send an indication of the new valid frame region of interest to the sink wireless device;
generate and encode video content of only the new valid frame region of interest as a new partial frame; and
send the new partial frame to the sink wireless device.

3. The wireless device of claim 1, wherein the session for mirror-casting of video content is a Miracast® End to End (E2E) session.

4. The wireless device of claim 3, wherein the frame of pure filling color is a frame of pure black.

5. The wireless device of claim 1, wherein the indication of the valid frame region of interest is an indication of a pixel height, a pixel width, and coordinates in a full frame of the valid frame region of interest.

6. The wireless device of claim 5, wherein the indication of the valid frame region of interest is a supplemental enhancement information (SEI) message.

7. A method for supporting mirror-casting of video content in a session established between a source wireless device and a sink wireless device, comprising:
generating and encoding a frame of pure filling color by a processor of the source wireless device in response to establishing a session for mirror-casting of video content with the sink wireless device;
sending, by the processor of the source wireless device, the encoded frame of pure filling color to the sink wireless device;
determining, by the processor of the source wireless device, a valid frame region of interest;
sending, by the processor of the source wireless device, an indication of the valid frame region of interest to the sink wireless device;
generating and encoding, by the processor of the source wireless device, video content of only the valid frame region of interest as a partial frame; and
sending, by the processor of the source wireless device, the partial frame to the sink wireless device.

8. The method of claim 7, further comprising:
determining, by the processor of the source wireless device, that a change in the valid frame region of interest occurred;
generating and encoding a new frame of pure filling color by a processor of the source wireless device in response to determining that the change in the valid frame region of interest occurred;
sending, by the processor of the source wireless device, the new encoded frame of pure filling color to the sink wireless device;
determining, by the processor of the source wireless device, a new valid frame region of interest;
sending, by the processor of the source wireless device, an indication of the new valid frame region of interest to the sink wireless device;
generating and encoding, by the processor of the source wireless device, video content of only the new valid frame region of interest as a new partial frame; and
sending, by the processor of the source wireless device, the new partial frame to the sink wireless device.

9. The method of claim 7, wherein the session for mirror-casting of video content is a Miracast® End to End (E2E) session.

10. The method of claim 9, wherein the frame of pure filling color is a frame of pure black.

11. The method of claim 7, wherein the indication of the valid frame region of interest is an indication of a pixel height, a pixel width, and coordinates in a full frame of the valid frame region of interest.

12. The method of claim 11, wherein the indication of the valid frame region of interest is a supplemental enhancement information (SEI) message.

13. A wireless device, comprising:
a wireless transceiver; and
a processor coupled to the wireless transceiver and configured to:
receive an encoded frame of pure filling color in response to establishing a session for mirror-casting of video content with a source wireless device;
decode the encoded frame of pure filling color as a first full frame;
receive an indication of a valid frame region of interest from the source wireless device;
receive an encoded partial frame from the source wireless device;
decode the encoded partial frame to generate a partial frame update for the valid frame region of interest;
apply the partial frame update to the first full frame to generate a new full frame; and
display the new full frame.

14. The wireless device of claim 13, wherein the session for mirror-casting of video content is a Miracast® End to End (E2E) session.

15. The wireless device of claim 14, wherein the frame of pure filling color is a frame of pure black.

16. The wireless device of claim 13, wherein the indication of the valid frame region of interest is an indication of a pixel height, a pixel width, and coordinates in a full frame of the valid frame region of interest.

17. The wireless device of claim 16, wherein the indication of the valid frame region of interest is a supplemental enhancement information (SEI) message.

18-22. (canceled)
